(19) United States
(12) Patent Application Publication
(10) Pub. No.: US 2018/0351382 A1
(43) Pub. Date: Dec. 6, 2018

(54) Power Supply Assembly

(71) Applicant: Owen Derek BARR, Gosford (AU)

(72) Inventor: Owen Derek BARR, Gosford (AU)

(21) Appl. No.: 15/779,474

(22) PCT Filed: Nov. 11, 2016
(86) PCT No.: PCT/AU2016/000379

§ 371 Date: May 25, 2018

(30) Foreign Application Priority Data
Nov. 27, 2015 (AU) 2015/904940

(51) Int. Cl. H02J 7/00

(52) U.S. Cl. CPC H02J 7/0063

(57) ABSTRACT

An assembly which includes an electrical power device, disposed within a building space, structure, vehicle, vessel or other solid object, and a switching mechanism. The electrical power device accepts electrical energy from battery power. The device converts input battery power into a form of electricity to suit the demand electrical apparatus. The switching mechanisms are activated by switches in a range of positions relative to the mechanism, to direct the appropriate electrical power into the demand electrical apparatus. This variety of switching mechanisms and switch activation, permits the power device to be installed apart from the demand electrical apparatus.

### INTRODUCTION

Currently, the electricity provided for most buildings is sourced from an external power grid, that starts at a power station, then to substations, then to street-substations, then to each building. There is considerable power loss at each change of power changeover as well as loss in the lines along the path of the supply, before the demand electrical apparatus receives power.

These existing systems all rely on installing electrical wiring throughout the building, vehicle, vessel or other solid object, from a meter box to each and every room or space. This is an expensive job requiring a skilled electrician and the use of expensive wire. In most cases the wiring is copper, which is becoming one of the metals which has a diminishing global supply and an increasing cost.

After a building, vehicle, vessel or other solid object has been constructed or fabricated, the job to introduce more demand electric power for power points or lighting becomes a further expense, with wiring required to be pulled through the frames of the existing building, vehicle, vessel or solid object. This causes disruption to tenants as well as more costs by trained contractors.

Recent disclosures describe a battery storage system, that receives power from the electricity grid and from solar panels, and store this energy in a battery. The purpose of this battery is to store solar power produced during sunlight hours and during off-peak periods collect power from the grid. Once stored in these batteries, the electricity can be released during peak demand times, using the stored energy from the solar panels and that of the cheaper rate, off-peak grid power.

### THE INVENTION

The invention is an assembly of an electric power device and a switching mechanism, wherein the electric power device is disposed within a building space, vehicle, vessel or other solid object. Electrical battery power is introduced into the device, wherein the battery power provides input electric power to the electric power device, which converts the input electrical power to an output electrical power. A switching process or mechanism directs output electrical power to a demand electrical apparatus, lighting, motor or an electrical circuit.

One embodiment of the invention describes portable batteries installed into the electric power device. These portable batteries may be removed from the electric power device, recharged or replaced before re-connecting to the electric power device.

Another embodiment of the invention describes a main-bank battery that provides electrical input power to the electric power device. The main-bank battery is located apart from the electric power device, and directs electrical power through hard wiring to the electric power device.

Another embodiment of the invention describes the electric power device, and switching mechanism as being disposed within a building space, vehicle, vessel or other supporting object, wherein the electric power device is apart from the demand electrical apparatus or fitment, to which it provides output electrical energy. In this embodiment the electric power device is connected to the demand electrical apparatus or fitment by electrical wiring, wherein the switching mechanism is connected to the electric power device and is activated manually.

A further embodiment of the invention describes the electric power device, and switching mechanism as being disposed within a building space, vehicle, vessel or other supporting object, wherein the electric power device is apart from the demand electrical apparatus or circuit to which the electric power device supplies demand electrical energy. In this embodiment the output electric power is connected to the demand electrical apparatus or circuit by an electric circuit of wires wherein the switching mechanism is connected to the electric power device, wherein the switch is activated by a remote switch.

A further embodiment of the invention describes the electric power device, and switching mechanism as being disposed immediately adjacent to the demand electrical apparatus or circuit, to which the electric power device provides demand electrical energy. In this embodiment the switching mechanism is connected to the demand electrical apparatus or circuit activated by a remote controlled switching device. Typical apparatus are lights, power outlets, television, which may require switching of the electrical power source from a distance.

A further embodiment of the invention describes the electric power device, and switching mechanism as being disposed immediately adjacent to the demand apparatus or fitment, wherein the electric power device and switch mechanism are connected to the demand electrical apparatus or fitment. In this embodiment of the invention the switching mechanism directs electric power from the electric power device to the demand electrical apparatus; wherein the switching mechanism is activated by manual switching. Typical apparatus include refrigerators and washing machines, wherein the switch that directs the electrical supply power, is built into the demand apparatus or fitment, with easy access.

A further embodiment of the invention described an electronic program wherein a number of demand electrical apparatus and switching mechanisms are connected to the power supply device by remote controls.

In a further embodiment of the invention the battery source provides Direct Current electrical energy.

In a further embodiment of the invention the battery source provides Alternating Current electrical energy.

In a further embodiment of the invention, the electrical power device includes an electric convertor that converts Direct Current into Alternating Current.

In a further embodiment of the invention, the electrical power device includes an electrical convertor that converts Alternating Current into Direct Current.

In a further embodiment of the invention, the electrical power device includes an electrical transformer that converts low voltage electric power to higher voltage electric power.

In a further embodiment of the invention, the electrical power device includes an electrical transformer that converts high voltage electric power to lower voltage electric power.

A monitor that displays the balance of energy while the battery is operating, warns the observer of pending loss of power. This display monitor allows replacement batteries to be available when required.

A further advantage of the invention is that a recharging mechanism could allow the portable batteries to be recycled at site or at a convenient location.

These portable batteries are sourced from convenient outlets with easily recognised classifications that define the particular demand usage for each battery. Packaging of these batteries should display an acceptable certification.

The electrical supply industry acknowledges that DC power is safer and more economical to transfer than AC power. However, since most electrical appliances are currently operating on AC power, these existing batteries will require the power supply device to convert DC power from the batteries to AC power by a “converter” that provides an output electrical power that suits the demand electrical appliance or circuit.

Another alternative is to have the DC power of the batteries converted to AC power before they are connected to the electrical power device, wherein the converted AC power can be transformed to a suitable voltage by a transformer within the device.

An advantage of the invention is that individual devices may be installed in separate locations, wherein each location has a separate energy demand. In this way the costs of supply (cost of batteries at each location) can be easily identified, so that each individual user pays for the energy used in each specific location.

The invention uses an innovative combination of materials and technology that are now available. The concept of having a selection of batteries and battery types to energies each particular apparatus, should create overall savings to consumers.

This invention will allow electrical energy to be available in remote areas without the need for power poles and power lines and delays in supply from the electric grid. This battery power electricity can be available much quicker than the grid based supply, and be increased in volume as a project demands.

The risk of electrical hazards can be reduced at building sites, marine vessels, and motor vehicles, as work may continue at each project before the batteries are installed and electrical power switched on.

Definitions: The following terms are included in this description:
(i) Electric power device: a device that converts battery electrical power into output electrical power as electrical energy for demand electrical apparatus;
(ii) portable battery: a battery that can be handled and installed into the device, and can be replaced and recharged;
(iii) main bank battery: a battery with a large supply of energy, usually located in a permanent position apart from the electrical power device, and connected to the electric power device by hard wiring;
(iv) switching mechanism: a mechanism that connects input power to outward power;
(v) remote switch: a process that activates a switching mechanism by remote control;
(vi) convertor; an electrical mechanism that changes one type of current to another type of current, from DC to AC or alternatively from AC to DC current;
(vii) transformer; an electrical mechanism that changes the voltage of input electrical power to another voltage for the outlet electrical power;
(viii) AC power: alternating current-electricity;
(ix) DC power: direct current-electricity;
(x) demand electrical apparatus: broader range of electrical items, machines and appliances that require electrical power;
(xi) appliances: single items that are powered by the device;
(xii) hard-wiring: wiring that transmits electricity between electrical apparatus that are apart;

### BRIEF DESCRIPTION OF DRAWINGS

FIG. 1: describes a portable battery 3 that supplies electrical power to an electric power device 1, wherein the battery 3 is installed directly 5 into the device 1.

FIG. 2: describes a main-bank battery 4 which is apart from the an electric power device 2, wherein the main bank battery 4 provides electrical input power through electric hard-wirings 6 to the electric power device 2.

FIG. 3; describes a switch mechanism 8 that is activated by a manual switch 9, wherein the electrical power from the electrical power device 7 is directed to the electrical demand apparatus 10 by the switch 9 and switching mechanism 8.

FIG. 4: describes a switch mechanism 11 that is activated by a remote switch 12 by remote activation 13, to direct electrical energy from device 7 to electrical demand apparatus 10.

FIG. 5: describes a device 7 that is apart from demand electrical apparatus 10, wherein the switch 9 manually activates the switching mechanism 8 which directs electrical power from device 7 through hard-wiring 14 to the demand electrical apparatus 10. In this configuration, the switching mechanism 8 is attached to or immediately adjacent to the device 7.

FIG. 6: describes a device 7 that is apart from demand electrical apparatus 10, wherein the remote switch 12 activates the switching mechanism 11 by remote connection 13; wherein the electrical power is directed from device 7 through hard-wiring 14 to the demand electrical apparatus 10. In this configuration, the switching mechanism 8 is attached to or immediately adjacent to the device 7.

FIG. 7: describes a device 7 that is apart from demand electrical apparatus 10, wherein the switch 9 manually activates the switching mechanism 8 which directs electrical power from device 7 through hard-wiring 14 to the demand electrical apparatus 10. In this configuration the switching mechanism 8 is attached to or closely adjacent to demand electrical apparatus 10.

FIG. 8: describes a device 7 that is apart from demand electrical apparatus 10, wherein the remote switch 12 activates the switching mechanism 11 by remote connection 13, wherein the switching mechanism 11 directs input electrical energy from device 7 through hard-wiring 14 to the demand electrical apparatus 10. In this configuration the switching mechanism 11 is attached to or closely adjacent to demand electrical apparatus 10.

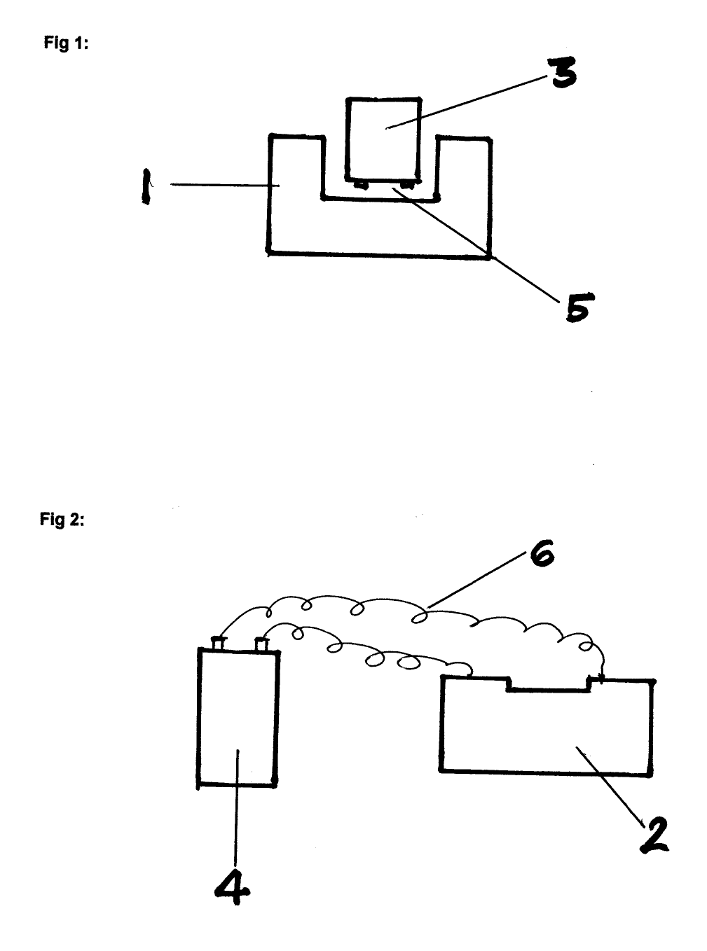

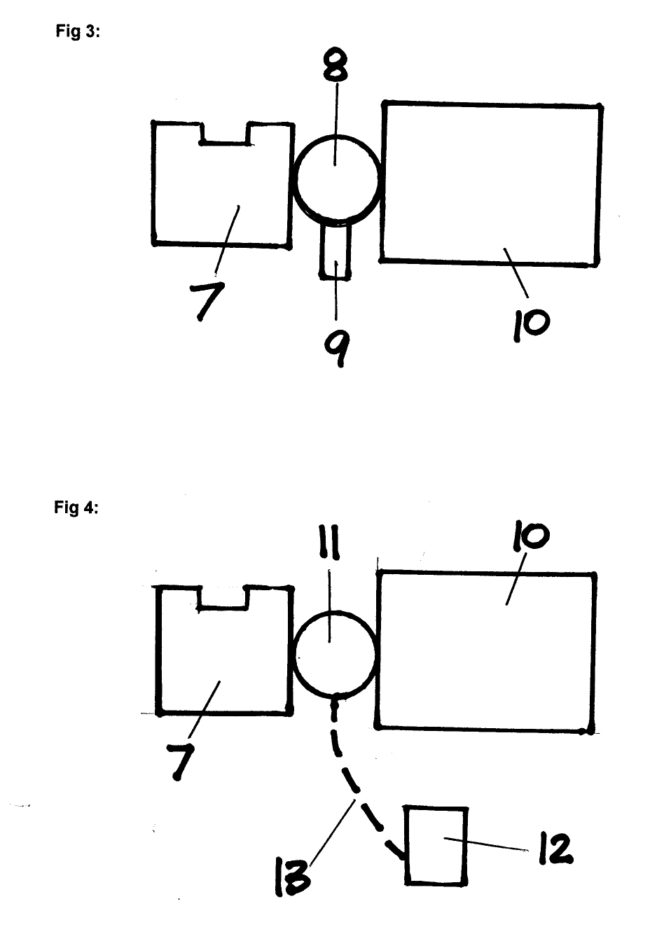

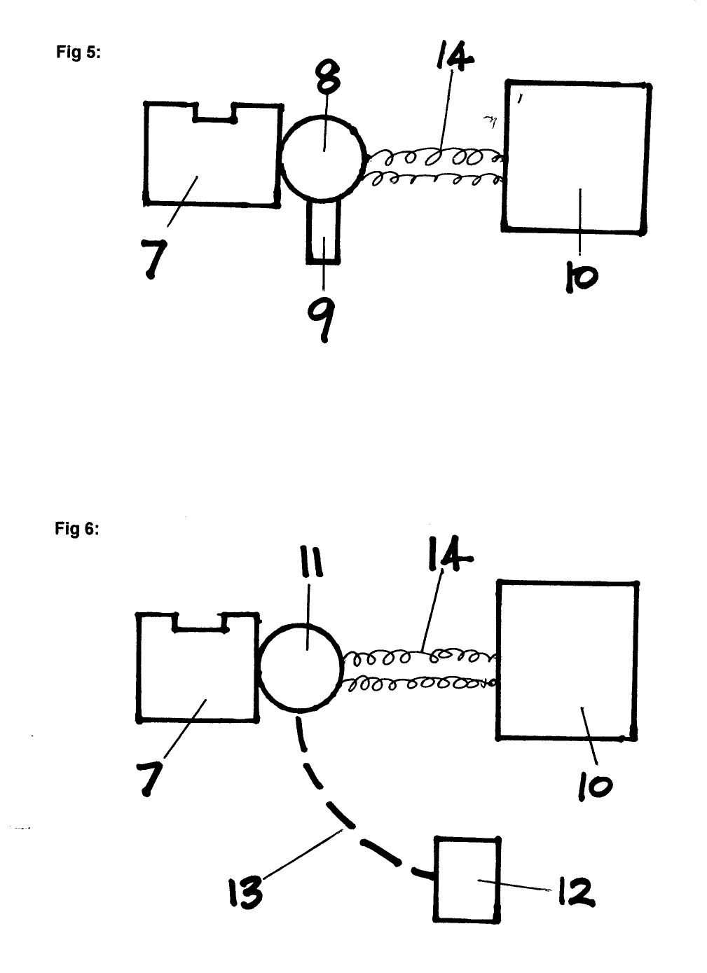

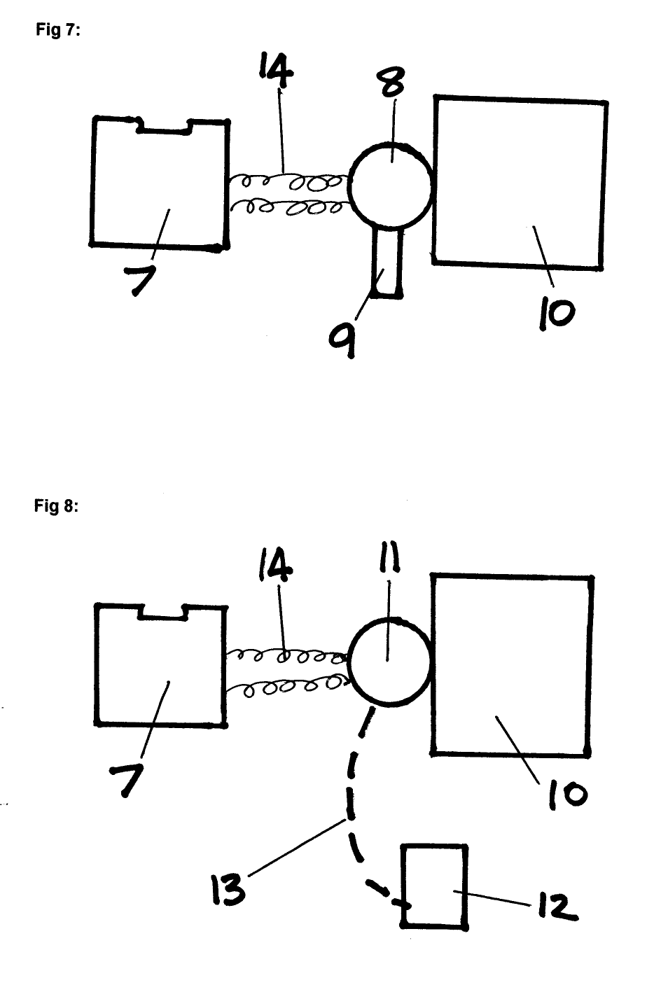

1. An assembly which includes an electric power device that is disposed within a building space, structure, vehicle, vessel or other solid object, and a switching mechanism; wherein the electric power device accepts electrical battery power to provide electrical input power; wherein the electric power device changes the input electrical power to output electrical power; wherein the output electrical power has the appropriate electrical power for use in a demand electrical apparatus or circuit; wherein the electric power device is connected directly or remotely to the demand electrical apparatus or circuit; wherein the switching mechanism directs the output electrical power to the demand electrical apparatus or circuit;

2. According to claim 1, the switching mechanism can be activated by a range of switch connections and locations including:
(i) manual switch located on or adjacent to the electric power device,
(ii) manual switch located on or adjacent to the demand electrical apparatus or circuit,
(iii) remote switch that activates a switching mechanism on the device,
(iv) remote switch that activates a switching mechanism on the demand electrical apparatus or circuit.

3. According to claim 1, wherein the electric power device includes an electrical converter which converts the input electrical power to an output electrical power that is appropriate electrical power used by the demand electrical apparatus or circuit.

4. According to claim 1, wherein the electric power device includes an electrical transformer which transforms the input electrical power to an output electrical power that is appropriate electrical power used by the demand electrical apparatus or circuit.

5. According to claim 1, the electric power device is made from materials that are thermally and electrically resistant, wherein the electric power device insulates the electrical circuits and magnetic flux within and surrounding the electric power device.

6. According to claim 1, wherein the range of demand electrical apparatus and circuits includes:
(i) appliances,
(ii) Motors,
(iii) lighting, and
(iv) electrical power outlets.

7. According to claim 1, the electric power device is ventilated to assist in efficient operation of the electric power device.

8. According to claim 7, the electric power device is positioned within a space that is ventilated;
wherein the ventilated space assists in efficient operation of the electric power device.

9. According to claim 1, the device is made from materials that are selected from a group of materials with features comprising: durability, resilience, waterproof and fireproof.

10. According to claim 1, wherein the electrical battery power introduces Alternating Current into the electric power device.

11. According to claim 1, wherein the electrical battery power introduces Direct Current into the electrical power device.

12. According to claim 1, wherein a portable battery provides electrical battery power into the electrical power device; wherein the portable battery is installed directly to the electrical power device.

13. According to claim 1, wherein a main-bank battery provides electrical battery power to the electrical power device; wherein a main-bank battery is apart from the electrical power device; wherein the main-bank battery is connected to the electrical power device by electrical hard-wiring.

14. A method of providing an assembly according to claim 1, that includes an electrical power device and switching mechanism as for claim 1, the steps comprising: assemble a device that accepts electrical battery power; wherein the device changes input electrical power to output electrical power; wherein the output electrical power is the appropriate power for the demand electrical apparatus or circuit; wherein the assembly provides a switching mechanism that directs output electrical power to the demand electrical apparatus or circuit.
